(19) United States
(12) Patent Application Publication
(10) Pub. No.: US 2023/0230715 A1
(43) Pub. Date: Jul. 20, 2023

(54) METHOD OF MEASURING NUCLEAR REACTOR FUEL TEMPERATURE

(71) Applicant: Xi'an Jiaotong University, Xi 'an City (CN)

(72) Inventors: Di Yun, Xi 'an City (CN); Zhengyu Qian, Xi 'an City (CN); Linna Feng, Xi 'an City (CN); Xiang Liu, Xi 'an City (CN)

(21) Appl. No.: 17/745,597

(22) Filed: May 16, 2022

(30) Foreign Application Priority Data
Jan. 18, 2022 (CN) 202210065314.4

(51) Int. Cl. G21C 17/06

(52) U.S. Cl. CPC G21C 17/06

(57) ABSTRACT

The invention relates to a field of nuclear reactor fuel temperature measurement and discloses a method of measuring nuclear reactor fuel temperature, comprising: S1: collect fission gas produced by nuclear reactors through a gas collection device, S2: measure pressure value and temperature value of the fission gas through pressure and temperature sensors, S3: obtain the corresponding fuel temperature by calculating the pressure value and temperature value, and the invention provides a method of measuring nuclear reactor fuel temperature, and it collects the fission gas discharged by fuels through a fission gas collection device, utilizes the sensitive relevance in a specific temperature range between the release amount of metal fuel fission gas and fuel temperature changes, and makes the pressure of metal fuel fission gas correspond to fuel temperature, thus to convert fuel temperature measurement which is difficult to achieve into fission gas pressure measurement which is easy to achieve.

### BACKGROUND OF THE INVENTION

### 1. Field of the Invention

The invention relates to a field of nuclear reactor fuel temperature measurement, in particular to a method of measuring nuclear reactor fuel temperature.

### 2. Description of the Related Art

Nuclear energy is a green and clean energy which utilizes nuclear reaction to generate energy, its carbon dioxide emissions are almost zero, and utilization of nuclear energy can effectively avoid environmental pollution and greenhouse effect, so developing nuclear energy is an important measure for the transformation of China's energy structure. Nuclear energy development is also limited by uranium resource reserves and large amounts of demands of water reactors on uranium resources, and to realize the sustainable development of nuclear energy, exploring new generation nuclear power technology and making technical innovations have become an important task in the current nuclear energy industry. In the background of efficient development of nuclear power, according to the worldwide experience and national conditions, China proposes the “three-step” development strategy of thermal reactors, fast reactors and fusion reactors. Among them, fast reactors, as a transitional reactor type, are mainly research objects in modern times. Fast neutron reactors at operation time will perform a conversion process from fissionable nuclides into fissile nuclides to increase the utilization rate of nuclear fuel resources, so as to increase the current utilization rate of thermal reactors on uranium resources from 1% to over 60%, and in the meantime, perform transmutation on long-lived radioactive wastes produced by thermal reactor operation, to greatly reduce the radioactive wastes. Fuels of fast reactors are diverse, including metal fuels, oxide fuels, carbide fuels and nitride fuels so on, wherein the metal fuels possess stronger neutron proliferation and higher safety performance, with relatively lower production technology requirements, and Chinese government plans to use metal fuels as the loading fuels of commercial demonstration fast reactors (Commercial Demonstration Fast Reactor, CDFBR) in the future, with better development prospects.

In the utilization of reactors, a problem that has remained unsolved for a long time is the measurement of fuel temperature. The limit of fuel temperature, especially the temperature not exceeding the safety limit during transient operation, is one of the quantitative criteria to ensure that fuels do not burn or melt, and the temperature limit is an important parameter in the safety analysis of nuclear reactors. In the reactors, conventional thermocouples cannot operate when the fuels are in the conditions of the high fission rate and high temperature, so the determination of fuel rod temperature has become a difficult problem in the field of fuel invention. In the normal operation, the fuel temperature can be calculated by inlet and outlet temperatures of coolants, but during the transient operation, the coolant temperature changes relatively slowly, and the method of calculating the fuel rod temperature by inlet and outlet temperatures of coolants possesses a longer delay time and an excessively large error.

For metal fuels, its unique fission gas release temperature dependence can provide a solution for transient temperature measurement of nuclear reactor fuels. When nuclear fuels produce fission reactions, fuels will produce large amounts of fission products, and inert gas in the fission products, due to their greatly low solubility in the fuel matrix, will exist in a gas form in the fuel matrix, and these gases will continuously gather, causing the swelling of fuels, and in the meantime, the fission gas will also reach the grain boundary through diffusion, form through holes at the grain boundary, and release to the outside world. The release of fission gas possesses a large relevance with the temperature, which can be used to obtain the fuel temperature by determining the amount of fission gas, and for the relevance between the release amount of metal fuel fission gas and the temperature, it can be obtained through the rate theory model.

For the invention of reactors loaded with high burnup metal fuels, due to the large release amount of fission gas, the fission gas needs to be released. If the fission gas is released to the primary circuit, its radioactivity will pollute the primary circuit system, which will cause great economy and security burdens for the reactor operation and maintenance. Therefore, it is necessary to specially collect the fission gas, further to inversely deduce the fuel temperature state by obtaining the fission gas pressure. Due to higher release amount of the fission gas from metal fuels themselves, the fission gas is released into the collection device through an exhaust device, the pressure and temperature sensors are used to measure the pressure and temperature of the released fission gas, and the instant temperature of fuels during transient operation is thus obtained by inverse deduction through the unique sensitive relevance in a specific temperature range between the release of metal fuel fission gas and the temperature.

### SUMMARY OF THE INVENTION

The invention provides a method of measuring nuclear reactor fuel temperature, and it collects the fission gas discharged by fuels through a fission gas collection device, utilizes the sensitive relevance in a specific temperature range between the release amount of metal fuel fission gas and fuel temperature changes, and makes the pressure of metal fuel fission gas correspond to fuel temperature, thus to convert fuel temperature measurement which is difficult to achieve into fission gas pressure measurement which is easy to achieve.

The invention provides a method of measuring nuclear reactor fuel temperature, comprising:

S1: collect fission gas produced by nuclear reactors through a gas collection device;

S2: measure pressure value and temperature value of the fission gas through pressure and temperature sensors;

S3: obtain the corresponding fuel temperature by calculating the pressure value and temperature value.

Optionally, the S3 is specifically as follows:

S31: obtain a total amount n1 of the produced fission gas through an ideal gas state equation PV=nRT, wherein P is the pressure value of the fission gas measured by the pressure and temperature sensors, and V is the volume of the gas collection device, R is a gas universal constant of the fission gas, and T is the thermodynamic temperature of the fission gas, the thermodynamic temperature of the fission gas is measured in real time through the pressure and temperature sensor;

S32: calculate and obtain a total release amount n2 of the fission gas produced at different temperature at some corresponding time through a rate theory model, and by comparing n1 calculated by pressure measurement with n2 calculated by the rate theory, when the two is equal, the temperature of the fuel at this time is obtained.

Optionally, S1 is specifically to connect the gas collection device with fuel elements of nuclear reactors, and the gas collection device is used to collect the fission gas produced by the fuel elements.

Optionally, S2 is specifically to provide the pressure and temperature sensors at inner side of the top of the gas collection device to measure the pressure value and temperature value of the fission gas.

Optionally, the pressure and temperature sensors are multiple.

Optionally, the outer periphery of the pressure and temperature sensors is wrapped with shielding layers, and the shielding layers are provided with apertures.

Optionally, the shielding layers are made of boron steel material.

Optionally, both the gas collection device and the fuel elements are wrapped inside containments.

Optionally, the fuel elements comprise multiple fuel rods, the fuel rods are connected with an exhaust system, and the exhaust system is connected with the gas collection device by pipelines.

Compared with the current technology, the beneficial effects of the invention are as follows: the invention can collect the fission gas released by metal fuels through the gas collection device provided in the upper part of a pressure vessel, measure the pressure and temperature produced by the fission gas through the pressure and temperature sensors, then obtain the real-time amount of the produced fission gas in combination with the ideal gas state equation, then calculate the corresponding production amount of the fission gas at different temperature through the classical rate theory model, and finally calculate with inverse deduction through artificial intelligence algorithm to obtain the real-time fuel temperature. Compared with the traditional temperature calculation method, the invention method is more accurate, with better timeliness.

### BRIEF DESCRIPTION OF THE DRAWINGS

FIG. 1 is a structural schematic view of a method of measuring nuclear reactor fuel temperature provided by the embodiment in the invention.

FIG. 2 is a variation diagram with temperature of the release rate of the fission gas provided by the embodiment in the invention.

### DESCRIPTION OF EMBODIMENTS

A detailed description of a specific embodiment in the invention is given below in combination with attached drawings, but what should be understood is that the protection scope of the invention is not limited by specific embodiments.

In the description of the invention, it should be understood that the orientation or positional relationship indicated by the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “axial”, “radial”, “circumferential”, etc. are based on the orientation or positional relationship shown in the drawings, and is only for the convenience of describing the invention and simplifying the description, but not indicate or imply that the pointed device or element must have a specific orientation, be constructed and operated in a specific orientation, and therefore cannot be understood as a limitation of the invention.

In the utilization of reactors, a problem that has remained unsolved for a long time is the measurement of fuel temperature. The limit of fuel temperature, especially the temperature not exceeding the safety limit during transient operation, is one of the quantitative criteria to ensure that fuels do not burn or melt, and the temperature limit is an important parameter in the safety analysis of nuclear reactors. In the reactors, conventional thermocouples cannot operate when the fuels are in the conditions of the high fission rate and high temperature, so the determination of fuel rod temperature has become a difficult problem in the field of fuel design. In the normal operation, the fuel temperature can be calculated by inlet and outlet temperatures of coolants, but during the transient operation, the coolant temperature changes relatively slowly, and the method of calculating the fuel rod temperature by inlet and outlet temperatures of coolants possesses a longer delay time and an excessively large error.

For metal fuels, its unique fission gas release temperature dependence can provide a solution for transient temperature measurement of nuclear reactor fuels. When nuclear fuels produce fission reactions, fuels will produce large amounts of fission products, and rare gas in the fission products, due to their greatly low solubility in the fuel matrix, will exist in a gas form in the fuel matrix, and these gases will continuously gather, causing the swelling of fuels, and in the meantime, the fission gas will also reach the grain boundary through diffusion, form through holes at the grain boundary, and release to the outside world. The release of fission gas possesses a large relevance with the temperature, which can be used to obtain the fuel temperature by determining the amount of fission gas, and for the relevance between the release amount of metal fuel fission gas and the temperature, it can be obtained through the rate theory model.

For the design of reactors loaded with high burnup metal fuels, due to the large release amount of fission gas, the fission gas needs to be released. If the fission gas is released to the primary circuit, its radioactivity will pollute the primary circuit system, which will cause great economy and security burdens for the reactor operation and maintenance. Therefore, it is necessary to specially collect the fission gas, further to inversely deduce the fuel temperature state by obtaining the fission gas pressure. Due to higher release amount of the fission gas from metal fuels themselves, the fission gas is released into the collection device through an exhaust device, the pressure and temperature sensors are used to measure the pressure and temperature of the released fission gas, and the instant temperature of fuels during transient operation is thus obtained by inverse deduction through the unique sensitive relevance in a specific temperature range between the release of metal fuel fission gas and the temperature.

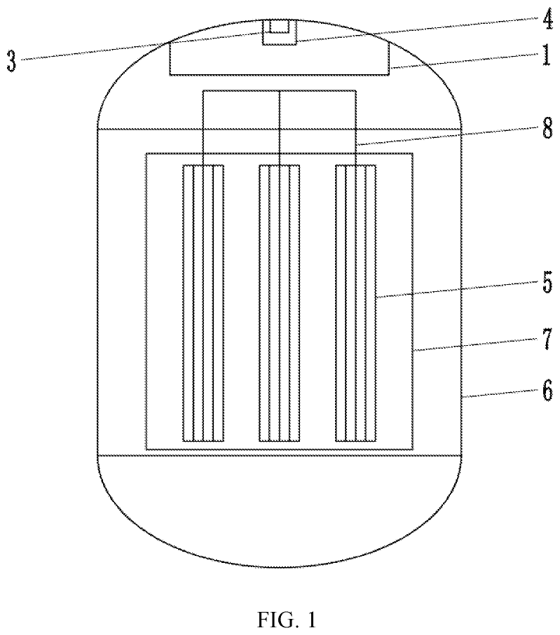

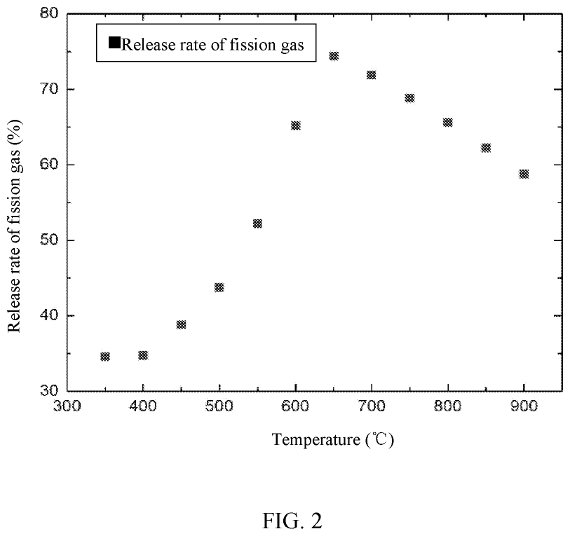

To solve the above technical problems, the invention provides a method of measuring nuclear reactor fuel temperature, to obtain the real-time fuel temperature, and a detailed description of technical schemes in the embodiments of the invention is given below in combination with attached drawings, wherein FIG. 1 is a structural schematic view of a device of measuring nuclear reactor fuel temperature provided by the embodiment in the invention, and FIG. 2 is a variation diagram with temperature of the release amount of the fission gas provided by the embodiment in the invention.

As shown in FIG. 1 to FIG. 2, the invention provides a method of measuring nuclear reactor fuel temperature, comprising:

S1: collect fission gas produced by nuclear reactors through a gas collection device 1;

S2: measure pressure value and temperature value of the fission gas through pressure and temperature sensors 3;

S3: obtain the corresponding fuel temperature by calculating the pressure value and temperature value, and the specific steps are as follows:

S31: obtain a total amount n1 of the produced fission gas through an ideal gas state equation PV=nRT, wherein P is the pressure value of the fission gas measured by the pressure and temperature sensors 3, and V is the volume of the gas collection device 1, R is a gas universal constant of the fission gas, and T is the thermodynamic temperature of the fission gas, the thermodynamic temperature of the fission gas is measured in real time through the pressure and temperature sensor;

S32: calculate and obtain a total release amount n2 of the fission gas produced at different temperature at some corresponding time through a rate theory model, and by comparing n1 calculated by pressure measurement with n2 calculated by the rate theory, when the two is equal, the temperature of the fuel at this time is obtained.

Optionally, S1 is specifically to connect the gas collection device 1 with fuel elements of nuclear reactors, and the gas collection device 1 is used to collect the fission gas produced by the fuel elements.

Optionally, S2 is specifically to provide the pressure and temperature sensors 3 at inner side of the top of the gas collection device 1 to measure the pressure value and temperature value of the fission gas.

Optionally, the pressure and temperature sensors 3 are multiple, and multiple pressure and temperature sensors 3 are mainly in reserve, if one loses efficacy, other data is available, and if one reading is different from the others, that means it is out of order, further to ensure the accuracy of the measured data.

Optionally, the outer periphery of the pressure and temperature sensors 3 is wrapped with shielding layers 4, and the shielding layers 4 are provided with apertures, the shielding layers 4 can insulate effects of fission neutrons on measurement results of the pressure and temperature sensors 3, and the apertures of the shielding layers 4 can collect the fission gas accommodated in the upper part of the gas collection device 1.

Optionally, the shielding layers 4 are made of boron steel material.

Optionally, both the gas collection device 1 and the fuel elements are wrapped inside containments 6.

Optionally, the fuel elements comprise multiple fuel rods 5, the fuel rods 5 are connected with an exhaust system, and the exhaust system is connected with the gas collection device 1 by pipelines 7.

Application method and working principle:

The current data shows the release amount of the fission gas possesses a large relevance with the temperature of metal fuels, different temperature corresponds to different release amount of the fission gas, and the release amount of the fission gas at a certain time can be obtained by the existing rate theory model. In the meantime, reactor cores of the fast neutron reactors in transient operating conditions possess the relatively better uniformity and the fuel element temperature of the reactor core possesses the relatively flat temperature, and the difference between maximum and minimum temperatures can be determined according to this stable temperature distribution. In the meantime, the fission gas of metal fuels is released in the specific temperature range, namely 550° C. to 650° C., with greatly high sensitivity to temperature changes. Thus, through the rate theory model, the inverse deduction algorithm of artificial intelligence, the fission gas collection device and the pressure and temperature sensors, the fuel temperature can be calculated relatively accurately, and when the metal fuels are in the steady-state operation below phase transition temperature and in the transient operation at 610° C. to 630° C. to produce phase transitions, large amounts of the fission gas will also be released, so the release spurt of the introduced fission gas against metal fuel phase transitions is more easily detected by the pressure and temperature sensors.

The fuel elements comprise multiple fuel rods, and the fuel rods are designed with an exhaust system, the produced fission gas can be released into the gas collection device through pipelines, and the fission gas will gather into the gas collection device, the pressure and temperature sensors are provided in the upper part of the gas collection device, and the pressure and temperature sensors are wrapped with the shielding material, to insulate effects of fission neutrons on measurement results of the pressure and temperature sensor, the apertures of the shielding layers can collect the fission gas accommodated in the upper part of the pressure vessel, to obtain the pressure produced by the fission gas released by metal fuels, and in combination with the ideal gas state equation PV=nRT, the total amount n1 of the produced fission gas is thus obtained. The total release amount n2 of the fission gas produced at different temperature at some corresponding time can be calculated and then obtained through the rate theory model, and by comparing the two, the temperature of the fuel at this time can be obtained relatively accurately. The gas collection device collects the fission gas released by all the fuel rods, and temperature differences exist among the fuel rods, and even though the temperature differences are not big, these existing differences make it impossible to establish the only corresponding relation between the total gas release amount and the temperature of all the fuel rods, so the release behaviour database of the fission gas from all reactor cores needs to be established, further to adopt artificial intelligence algorithm to inversely deduce and then obtain the temperature distribution of reactor core fuel rods.

In the invention, by multiple pressure and temperature sensors provided in the upper part of the fission gas collection device and wrapped with the shielding material, we can obtain the pressure produced by the fission gas released by metal fuels at different time.

In the invention, a matter of concern is the relevance calculation between the release amount of the fission gas and the temperature. The invention plans to adopt the rate theory model used in fission gas release calculation for a long time as the tool for calculating the fission gas release amount, and we can obtain a relevance diagram as shown in FIG. 2 between the release rate of the fission gas and the temperature, through the rate theory model, while the release amount of the fission gas is equal to the product of gas production amount and release rate, and not hard to see, the release amount of the fission gas is quite different at different temperature, and especially in the temperature range during transient operation of fuels, there are very sensitive corresponding relations between the fission gas release and the temperature. The fuel rod temperature can be calculated relatively accurately by this point.

What is disclosed above is only several specific embodiments, but the embodiments of the invention are not limited herein, and any change that can be considered by technicians in the field shall all fall within the protection scope of the invention.

1. A method of measuring nuclear reactor fuel temperature, comprising:
S1: collect fission gas produced by nuclear reactors through a gas collection device;
S2: measure pressure value and temperature value of the fission gas through pressure and temperature sensors;
S3: obtain the corresponding fuel temperature by calculating the pressure value and temperature value.

2. The method of measuring nuclear reactor fuel temperature according to claim 1, wherein the S3 is specifically as follows:
S31: obtain a total amount n1 of the produced fission gas through an ideal gas state equation PV=nRT, wherein P is the pressure value of the fission gas measured by the pressure and temperature sensors, and V is the volume of the gas collection device, R is a gas universal constant of the fission gas, and T is the thermodynamic temperature of the fission gas, the thermodynamic temperature of the fission gas is measured in real time through the pressure and temperature sensor;
S32: calculate and obtain a total release amount n2 of the fission gas produced at different temperature at some corresponding time through a rate theory model, and by comparing n1 calculated by pressure measurement with n2 calculated by the rate theory, when the two is equal, the temperature of the fuel at this time is obtained.

3. The method of measuring nuclear reactor fuel temperature according to claim 1, wherein the S1 is specifically to connect the gas collection device with fuel elements of nuclear reactors, and the gas collection device is used to collect the fission gas produced by the fuel elements.

4. The method of measuring nuclear reactor fuel temperature according to claim 1, wherein the S2 is specifically to provide the pressure and temperature sensors at inner side of the top of the gas collection device, to measure the pressure value and temperature value of the fission gas.

5. The method of measuring nuclear reactor fuel temperature according to claim 4, wherein the pressure and temperature sensors are multiple.

6. The method of measuring nuclear reactor fuel temperature according to claim 4, wherein the outer periphery of the pressure and temperature sensors is wrapped with shielding layers, and the shielding layers are provided with apertures.

7. The method of measuring nuclear reactor fuel temperature according to claim 6, wherein the shielding layers are made of boron steel material.

8. The method of measuring nuclear reactor fuel temperature according to claim 3, wherein both the gas collection device and the fuel elements are wrapped inside containments.

9. The method of measuring nuclear reactor fuel temperature according to claim 3, wherein the fuel elements comprise multiple fuel rods, the fuel rods are connected with an exhaust system, and the exhaust system is connected with the gas collection device by pipelines.
